(19) United States
(12) Patent Application Publication
(10) Pub. No.: US 2024/0119736 A1
(43) Pub. Date: Apr. 11, 2024

(54) System and Method to Facilitate Monitoring Remote Sites using Bandwidth Optimized Intelligent Video Streams with Enhanced Selectivity

(71) Applicant: Jack Wade, La Jolla, CA (US)

(72) Inventor: Jack Wade, La Jolla, CA (US)

(21) Appl. No.: 18/222,443

(22) Filed: Jul. 15, 2023

Related U.S. Application Data
(60) Provisional application No. 63/389,816, filed on Jul. 15, 2022.

(51) Int. Cl. G06V 20/52; G06V 10/25; H04N 23/90

(52) U.S. Cl. CPC G06V 20/52; G06V 10/25; H04N 23/90

(57) ABSTRACT

Proposed is a remote monitoring apparatus that delivers video from local sites to one or more remote monitoring centers using video streams that are encoded to optimize bandwidth. Users can specify the routing of video streams and the formatting or enhancement to be applied to one or more video streams. The present invention offers a remote monitoring system to survey events via a local computer with a series of network systems, remote sensing cameras, and auxiliary equipment to further capture events. When auto-alerts or mouse click events occur, live streams at the next higher resolution format ensue, allowing supervisors to monitor large areas using super frames. Recorded events are monitored through convenient actions that streamline the process of handling incidents in airport environments, by highlighting areas of interest and creating super frames, a live stream of available camera views that display at high levels with the most efficient bandwidth for preferable resolution. Embodiments of the invention allow one to surveil events with preset specifications for a more effectual approach with consideration to bandwidth.

### CROSS REFERENCE TO RELATED APPLICATIONS

This application claims the benefit of U.S. Provisional Patent Application Ser. No. 63/389,816, filed Jul. 15, 2022, which is incorporated herein in its entirety.

### TECHNICAL FIELD

The technology disclosed herein relates to combining video feeds from multiple video cameras into a single video stream that can be efficiently routed to various destinations, utilizing bandwidth optimization features for efficiency.

### BACKGROUND OF THE INVENTION

The issue of visual fatigue is an apparent consequence of viewing and monitoring data or footage without supplemental technology. A person viewing a video display may overlook specific essential details within the displayed field of view. With eyestrain, operators may lose sight of discrete exchanges or other angles of the video stream because they are hyper-fixated on one subject or action. The present invention is a more technical, holistic approach, as it does not merely produce video streams but a pre-programmable filtration method that can also analyze frames, as seen in highlighted areas of interest. This can be used in military environments, wherein an area of interest is a line of demarcation, such as a border, or other relevant, protected territory. The ability to alert to abnormal activity in a region of interest, trigger alerts, and capture clear, detail-oriented frames of the occurrence is a feature of origination in the present invention. For example, this feature would be immensely valuable in military surveillance applications.

### SUMMARY OF THE INVENTION

The invention disclosed herein describes a means of combining video feeds from multiple video cameras into a single video stream that can be efficiently routed to various destinations, utilizing bandwidth optimization features for efficiency. The concatenated stream combines metadata relating to the source camera and the destination video display. The system implements AI, video analytics, and algorithms to trigger alerts on identified conditions and notify users. The invention enables sophisticated multicamera-multisite autonomous monitoring capabilities and provides a more dynamic and rich viewer experience in surveillance applications. The remote video monitoring and transmission system flourish in various industries, including but not limited to civil aviation remote Air Traffic Control (ATC) systems, apron monitoring systems, traffic command centers, military environments, and any destination wherein remote video monitoring is implemented and required.

The present invention describes a system and method for managing transportation hub assets by utilizing discrete intelligent video streams with optimized bandwidth and enhanced selectivity. Currently, remote video monitoring has been used in various fields and sectors. The purpose of remote monitoring is to surveil the remote situations through the local computer using network systems, remote sensing cameras, and other auxiliary equipment. Parts of the images and sounds are recorded to provide convenient reference material and an essential basis for handling incidents in airport environments. The remote video surveillance system has vast reach through standard telephone lines, networks, mobile broadbands, ISDN data lines, or direct connections. It also administers the pan, tilt, and lens of video surveillance images and preserves imagery.

The present invention offers a solution to transmit video information collected by one or more local cameras to the remote end in real-time, thus effectively utilizing the transmission bandwidth. It should be noted that the parameters that control the bandwidth are resolution, frame rate, color depth, color model and the selected area of interest (AOI), a mouse designated smaller area within the field of view, and other parameters relative to a codec that controls compression. The following system and methods remedy other issues, such as poor or reduced image resolution due to limited bandwidth or the problem of overburdening bandwidth resources with unnecessary or extraneous video footage.

The disclosed invention introduces several solutions for optimizing video bandwidth. Through AI video analysis, a user can utilize artificial intelligence to identify authorized activities, support multiple command centers, and utilize interactive and collaborative viewing functions. In short, the approach allows a user to designate an area to be monitored and the rules that trigger upon violation. As a result, the system responds in accordance with a pre-defined plan. For example, the system could be configured to notify users when a geofenced area is encroached. This area can be specified with a mouse click or through the network API definition. Additional customizations, like identifying markers such as abnormal weight, or other characteristics, may also be implemented at the user's discretion. Users can define rules for each camera and specify the transmission image resolution. Users can also specify an interval after which an alarm is automatically reenabled following a violation. The system supports real-time automatic alarms for multiple users at the remote end through the manifestations of sound, light, video, and screenshots. These novel camera settings enable more effective surveillance options with more efficient bandwidth utilization.

By way of example, some definable rules may include but are not limited to the following: unauthorized intrusion, recognition and tracking of specific moving objects, collision warnings, speed warnings and failures to follow established routes, alerts on designated targets, the position of the observation target changes. When a defined rule is violated, the corresponding actions taken by the system may include, but are not limited to: adjustments to resolution and refresh rates of the video transmissions with respect to presets, alerts to the pre-set remote user by marking or acousto-optic signals on the corresponding screen of the super frame, and automatic replays of transgressions.

The system's architecture uses a super frame to transmit video on a digital network. Encoding, transcoding, and decoding individual streams, especially multiple streams, can require extensive computational resources. In the aforementioned system, each camera streams image frames to a computer that compresses the stream for transmission across the network using individual bandwidth optimization settings for the respective camera. Users are also allowed the option to stream content in a lower bandwidth (“Quiet Surveillance”) mode, which varies compression settings, or a higher bandwidth (“Alerted/Zoom”) mode, which adjusts the camera's settings for higher resolution, frame rates, the field of view, full color and other elements. By combining streams into a larger super frame, the issue of encoding and decoding can be streamlined. Integration and encoding of multiple videos into one super frame for transmission enables a user to carry out high-level monitoring with optimal bandwidth. The super frame uses a grid layout, for example, a nine-square grid, to intuitively display real-time thumbnails of multiple videos on one screen. The thumbnails are transmitted at lower resolutions to conserve bandwidth and clickable to greater resolutions to provide greater detail as needed by the user. Each channel of the displayed video is rooted in the principle of effective use of resources and user preferences to institute the best video format. Each camera's video stream enables customization relative to resolution, frame rate, color depth, the overall or partial field of view, size, and positioning on the super frame. The architecture allows more user control over how recorded views are presented, combining individual views from the super frame in the desired arrangement.

As previously mentioned, the present invention is suitable for use in military environments for surveillance applications. With visual fatigue, operators may lose sight of discrete exchanges or other areas of interest that may be valuable to grasp. The present invention is a more technical approach to the problem. It does not merely produce video streams but a pre-programmable image processing method that can analyze frames and highlight areas of interest.

Local sites can forward footage to other remote locations in military applications, where an area of interest is a line of demarcation, such as a border, or other relevant, protected territory. The ability to alert to abnormal activity in a region of interest, trigger alerts, and capture clear, detail-oriented imagery of the occurrence is a feature of the present invention. For example, when a person or unauthorized object crosses a line of demarcation, a set of customizable, pre-set responses are triggered. The technology of the present invention also enables monitoring through an analysis of a set of characteristics, not limited to weight, height, size, and other markers. Having a local site that stores, encodes, and archives video streams that can be pushed to different destinations for surveillance is valuable in military operations, as centers can now communicate, exchange and monitor views and data without the concern of visual and individual fatigue. Centers can also access more curated feeds, which can help filter out obstruction, pinpoint anomalous activity, and ensure maximum efficiency and reporting.

When an automatic alarm or mouse click event is triggered, the next higher resolution real-time stream initiates, thus allowing viewers to use super frames to monitor large areas and increase the resolution of the displayed video as prompted. This feature aids transmission efficiency and reduces the workload associated with remote monitoring personnel. This process also streamlines the transmission of parts of each video frame that are points of interest to the user, as it ignores the transmission of the unrelated or non-selected elements. Users can request a sequence of scales and copies of source imagery from within the super frame to combine into a new mosaic to view. All streams that are sent are a transcoding of the original super frame. Each can combine all or any subset of the subframes, typically individual camera views or regions of interest, of the original, a key feature in bandwidth savings. As envisaged, there are also video recording DVR controls, bookmarks, and collaborative monitoring. In addition, it supports local backup of videos at full resolution and full refresh rate, as well as remote retrieval and playback. The footage from each camera is cached on the local site and can be paused, played forward and backward, and bookmarked at the remote end. This is all accomplished using a small collaboration window, which features drop-down boxes for sharing bookmarks and chat alerts with participants in multiple remote command centers.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation in the figures of the accompanying drawings. Having thus described the invention in general terms, reference will now be made to the accompanying drawings, which are not necessarily drawn to scale, and wherein:

FIG. 1 is a depiction of exemplary use at a major metropolitan airport. Highlighted via the red outlined box is an area of interest and command centers where the feed is projected and the Local Site's Settings Page for each camera.

FIG. 2 is the system process of an embodiment of the invention deployed in the environment of FIG. 1.

FIG. 3 exhibits the steps in the transmission process from local sites to one or more remote monitoring centers, and their variants based on user requests and functions.

FIG. 4 exhibits the steps in delivering video from local sites to one of more remote monitoring centers, including detailed notes

FIG. 5 shows how images with different frame rates, sizes, and perspectives can be enhanced, rectified, and trimmed to create a better view, including a panoramic view.

FIG. 6 show the three memory resident tables used to control the processing, formatting, and routing of the video from remote sites to central monitoring centers.

FIG. 7 is a pseudocode representation showing how two tables, the CameraTables and SuperFrameTables are used to manage cameras and user interactions.

FIG. 8 is a pseudocode representation of a method for conserving bandwidth as implemented in the local site.

FIG. 9 is a pseudocode representation of a method for conserving bandwidth as implemented in the remote site.

### DETAILED DESCRIPTION OF THE PREFERRED EMBODIMENT

Before describing the invention in detail, it is useful to describe an exemplary environment in which it can be implemented.

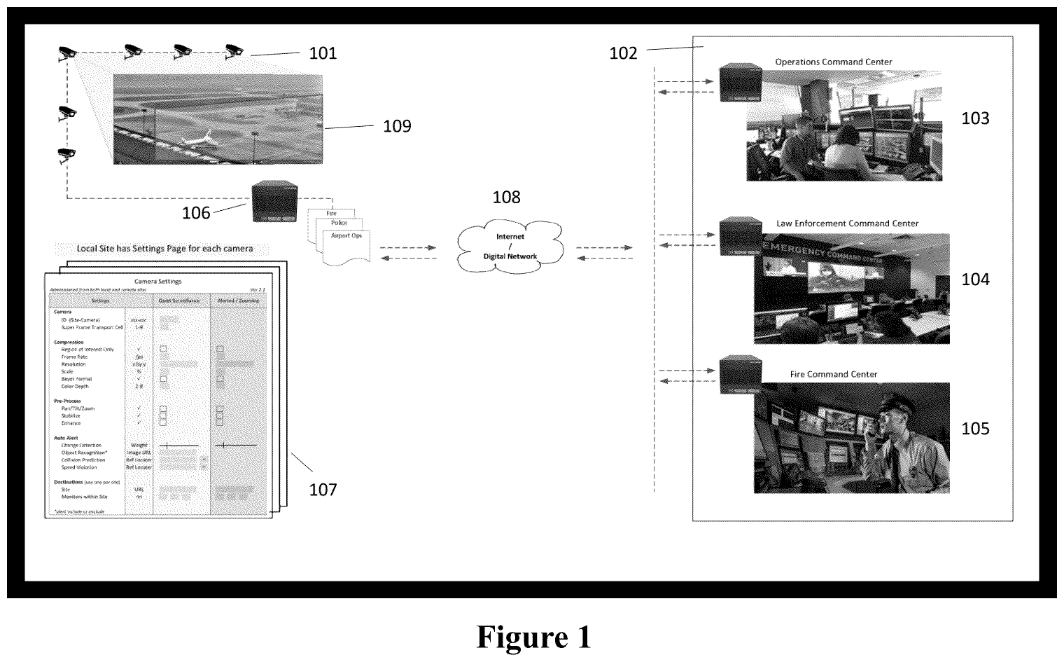

One such example is that of a major metropolitan airport, an example of which is shown in FIG. 1. Multiple cameras monitor various regions of interest inside and outside terminal building 101. Outdoor areas of interest may include the apron (where airplanes park to board passengers and refuel), taxiways, runways, and airstrips. Additional areas of interest may include public and private sections of the terminals, control towers, lines of demarcation, borders, military bases, hangars, and parking areas. Video streams from various cameras may be routed over the Internet or other digital network 108 to various destination command centers or hubs 102, including operations 103, law enforcement 104, and fire fighting 105. A local computer 106 is associated with the array of cameras and maintains settings pages for each camera 107. A settings page indicates the destination for the camera's video feed and designates various parameters relating to video format options, alert triggers, and modes, which may invoke an alternate set of predefined video format options. For each camera, there exists one settings page for each designated destination.

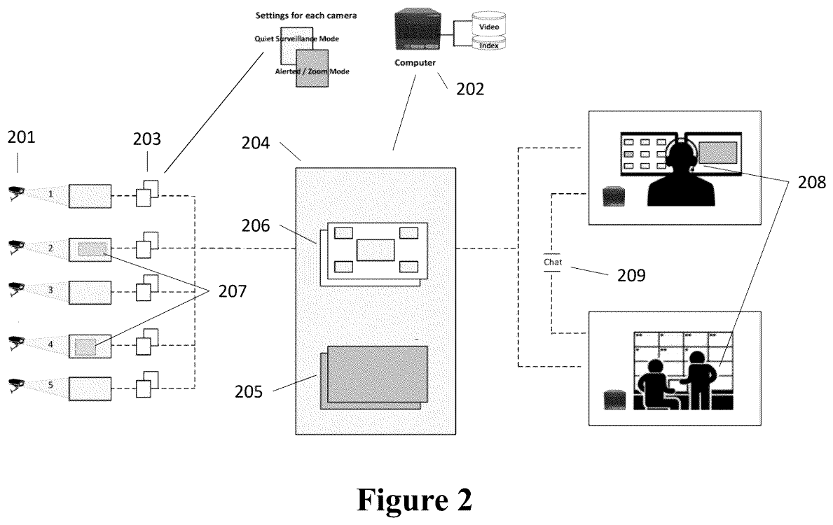

FIG. 2 illustrates an exemplary system process of an embodiment of the invention deployed in the environment of FIG. 1. An array of two or more video cameras 201 that can be configured to capture various scenes from an area of interest are connected to a local computer 202. The local computer 202 stores the settings pages 203 for each camera. Each camera streams image frames to the local 202 computer, which creates a single super frame video stream for each destination based on the settings pages. The super frame is a live stream of available camera views for a viewer to monitor at a high level at the most efficient bandwidth. When an auto-alert or mouse click event occurs, a live stream at the next higher resolution format kicks in. This enables supervisory staff to monitor a large area using the super frame and click into a tighter view when needed. Weight and other characteristics may be monitored in addition to aberrant activity in the designated area of interest.

The local computer constructs each super frame video stream by formatting each of the cameras' feeds per the requirements for the destination and adding metadata as indicated in the camera's settings page 204. The local computer then concatenates all the formatted video feeds for a specific destination and compresses the video super frame stream for transport over digital networks. The system can be configured to identify particular trigger criteria to invoke an alert mode 205. Alerts can be generated by algorithms that apply artificial intelligence and change detection to alert viewers to abnormal conditions. The systems can also be configured for geofenced area monitoring such that when the system detects a change in the selected area 109, an alert is generated. For example, AI can validate moving objects using a library of authorized images; path prediction of moving objects could be applied to alert of potential collision; vehicle speeds and routes could be monitored.

The system can also be configured to invoke a quiet mode 206 in the absence of any triggering event. The destination settings page for each camera contains separate parameter settings for quiet mode and one or more alert modes. The local computer constructs the super frame video stream using the parameters specified for the current mode. The mode can change on the fly depending on whether a triggering event, algorithm, or user command invokes a change in mode.

A computer at the local site manages each camera's settings and ingests its video 204. As the stream is received, AI and image analysis algorithms are applied to trigger an alert on identified conditions, notify viewers of abnormal conditions, and optionally switch into a higher fidelity (“Alert/Zoom”) mode. The system can be configured to use a visual memory bank To alert users upon a “first time sighting” of a specific type of objects which merit a much higher degree of scrutiny. For example, a collection of trucks images would enable an AI engine to identify an object as a “truck.” Once an object has been classified, a historical archive of related object types can be searched for a match. If a match is found, statistics can be collected for future analytics. If the object is not found, a new entry is created, and an alert is issued for a “first time seen”.

Metadata is superimposed on each video frame, and the stream is recorded. Because video streams contain compressed data and are variable length, a synchronized companion file is generated that indexes the file for random access retrieval using metadata, time stamps, and any identified descriptors identified by the AI and analytic algorithms.

Quiet mode 206 may be used to conserve bandwidth or other system resources by varying settings for compression, resolution, frame rate, area of interest, color depth, and others. This system also allows a viewer or programmatic method to designate only a portion of the video frame, defined as the area of interest (AOI) to be transmitted 207. For example, a viewer can indicate an AOI by selecting a portion of the displayed image using a mouse interface 207. Transmitting only a portion of the frame can be done to conserve bandwidth. It can also be done to provide a zoomed-in image.

Alert mode, sometimes called zoom mode, can stream higher image fidelity by changing the camera's settings for higher resolution, frame rate, full FOV, full color, and so on. This allows the system to conserve resources by providing high-resolution images only when needed since a surveillance system typically spends most of the time in the untriggered quiet mode.

The system allows viewers to switch between modes when investigating events 208. Viewers can use DVR controls (pause, play, back. forward, bookmark) or add frame-accurate voiceover commentary to the metadata associated with the video stream.

A “chat” capability is provided for intra-site communication 209.

Because the video from each camera is cached at the local site, it is available for immediate pause, rewind, play forward, and bookmarking. The “DVR Live” capability provides immediate access to the recorded steam as it is being recorded. This enables viewers to pause, skip back, apply analytics (zoom in, watch in slow motion, apply algorithm(s)), jump forward, or back to live. Further, the DVR Live mode can be shared in real-time with other destinations assisted by the chat function as needed. The DVR Live function also supports Frame grabs and extracting clips as the video progresses and allows the extracted content to be routed (also in real time) to other network destinations. Viewers at the local site can collaborate and share bookmarks and chat alerts with participants at remote command centers. This feature also allows those in different bases of operation to exchange information with more immediacy, and in some instances, with more specifications depending on the course of action.

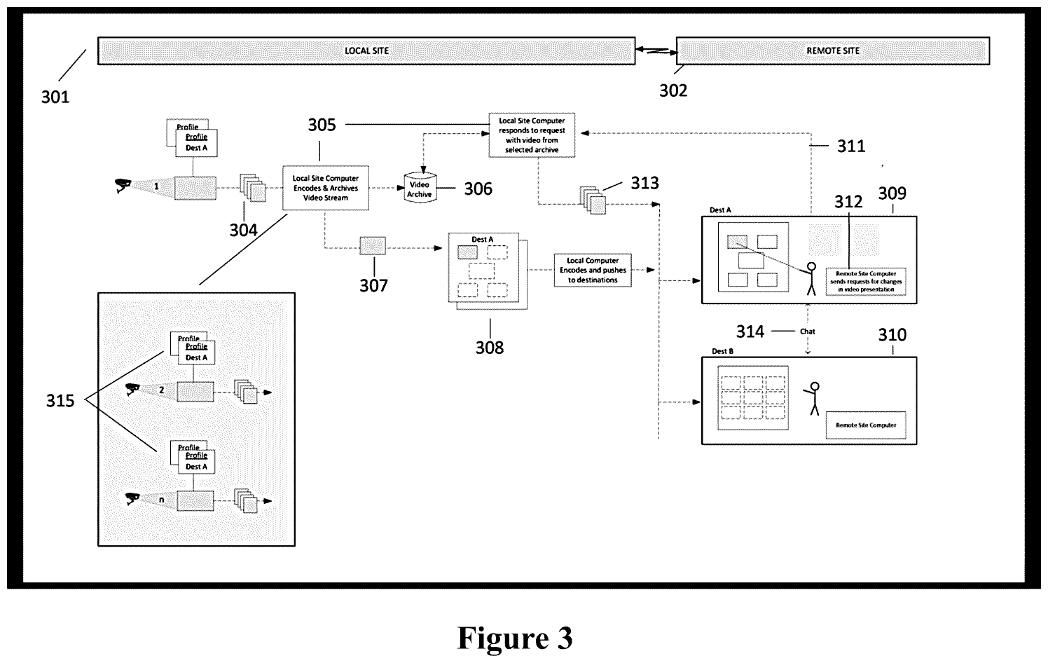

FIG. 3 shows the steps in delivering video from local sites 301 to one or more remote monitoring centers 302. A local site computer 305 manages profiles for multiple cameras 315. Each camera is initialized with settings unique to each remote destination 303. Each camera sends raw frames 304 to a local computer 305 for processing. The local computer 305 encodes and stores video streams in the video archive 306 and creates “Preview Frames” 307 based upon a camera's destination profile (aka page settings). The preview frame 307 with a link to the archived stream 306 is incorporated into the super frame 308 and pushed to a destination 309. A viewer at a destination 309 can request changes in video stream formats. In this case, the remote site computer 312 sends a request 311 for changes in the video presentation. Requests might include pause, play, backward, forward, bookmark, or clip.

Additional requests can include higher resolution, faster frame rate, expanded view, etc. The local site computer 305 responds with a video selected 313 from the archive 306 and sends it to the request destination 309. Viewers at various destinations can communicate with each other using the systems chat 314 capabilities. As a result, viewers using the systems chat 314 may use these features and forward information, data, footage, or commentary to different bases of operation.

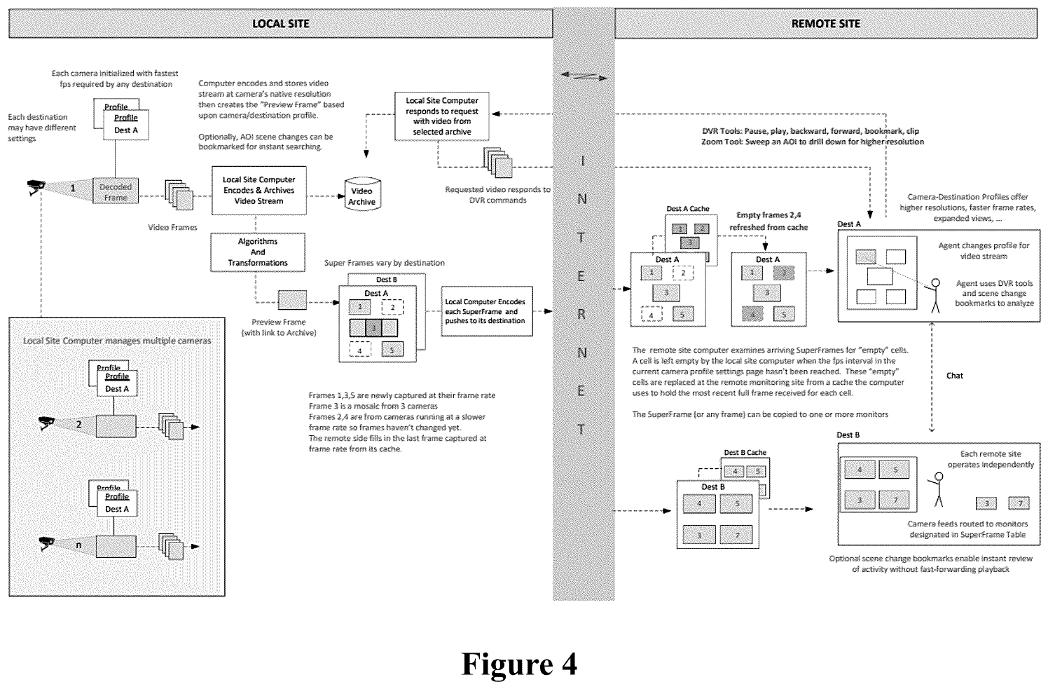

FIG. 4 exhibits the steps in delivering video from local sites to one of more remote monitoring centers, including detailed notes.

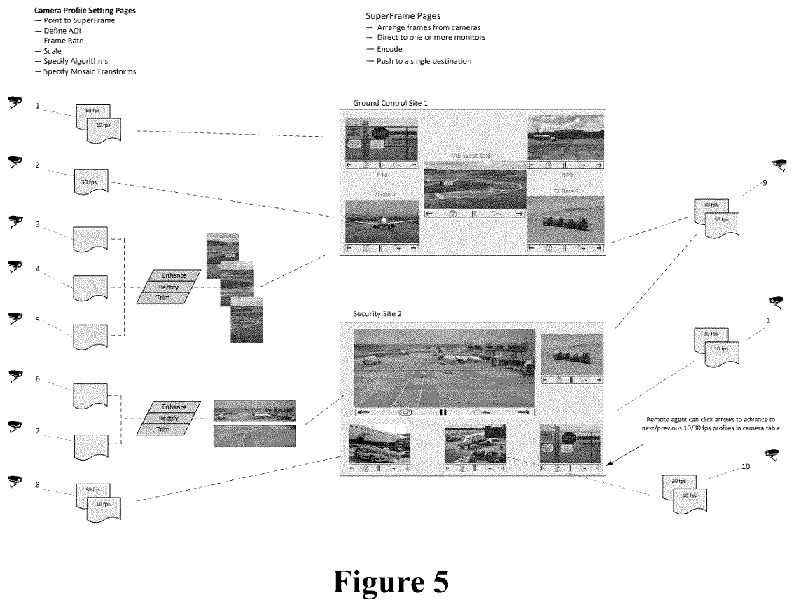

FIG. 5 shows how multi-camera wide area panoramic images can be constructed using video streams with different frame rates, sizes, and perspectives. Imagery can be enhanced, rectified, and trimmed to create a better view, including a panoramic view. Additionally, remote viewers can dynamically command a change in camera encoding profiles in a carousel fashion to match viewing preferences to live content. This allows a remote viewer to “drill down” to greater visual acuity by clicking the image to move to the next profile in the carousel. Users can dynamically select encoding options for each camera including the area of interest, frame rate, resolution, scaling factor, color depth, etc.

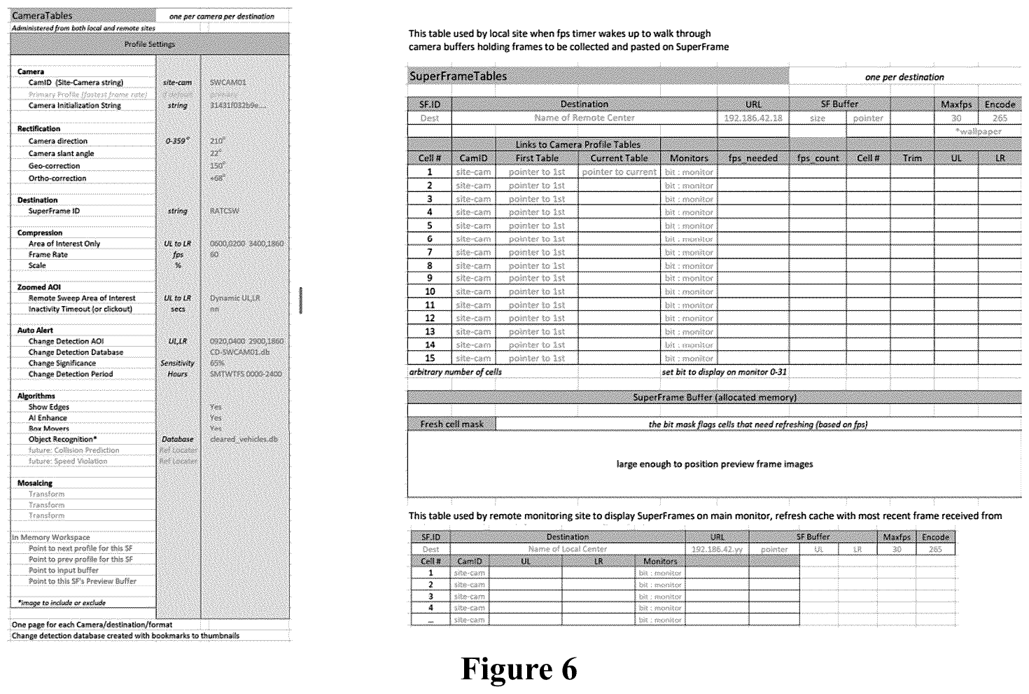

FIG. 6 shows the memory resident tables used to control the processing, formatting, and routing of the video from remote sites to central monitoring centers. There is one CameraTable per destination. CameraTables can be administered from both local and remote sites. The SuperFrameTables are used by the local site when the frames per second (fps) timer wakes up and triggers the SuperFrame Manager to walk through camera buffers holding frames to be collected and pasted on SuperFrame. There is one SuperFrameTable per destination. The SuperFrame Buffer and associated buffer table is used by remote monitoring site to display SuperFrames on main monitor, refresh cache with most recent frame received.

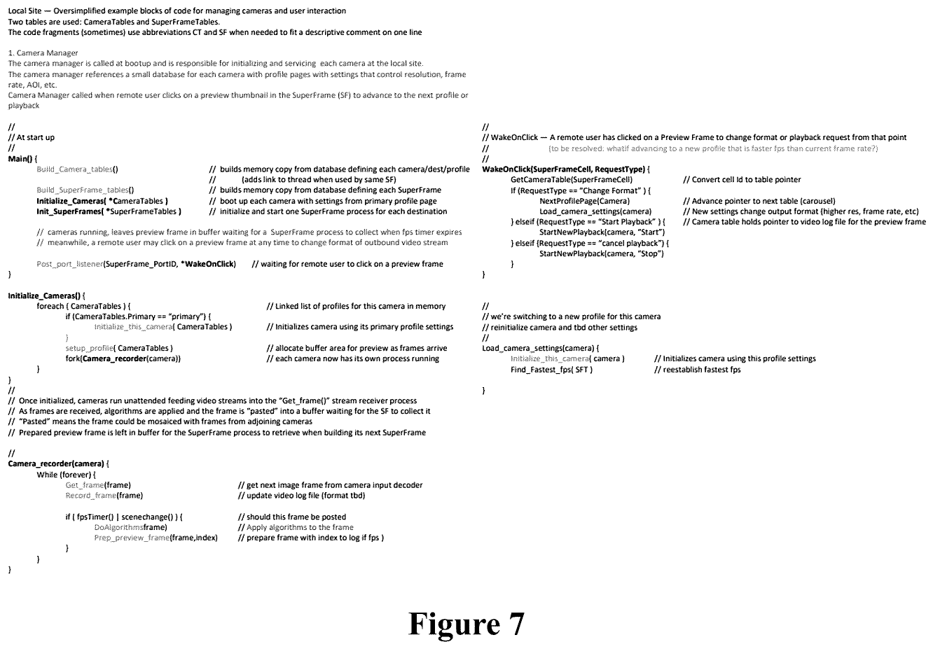

FIG. 7 is a pseudocode representation showing how the Camera Manager uses the CameraTables and SuperFrameTables to manage cameras and user interactions. The Camera Manager is called at bootup and is responsible for initializing and servicing each camera at the local site. Camera Manager references a small database for each camera with profile pages with settings that control resolution, frame rate, AOI, etc. Camera Manager is called when remote user clicks on a preview thumbnail in the SuperFrame to advance to the next profile or playback,

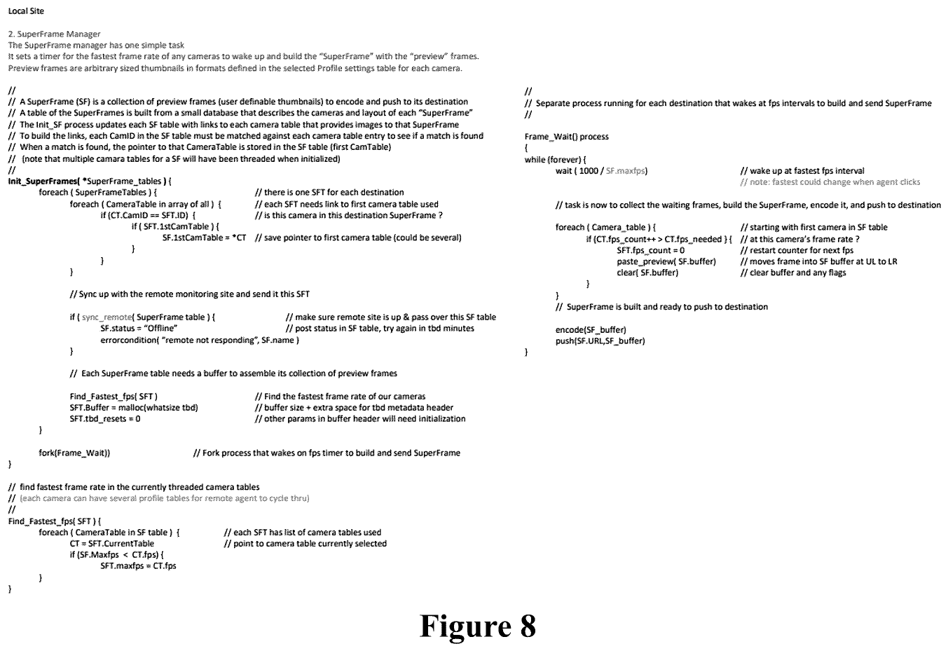

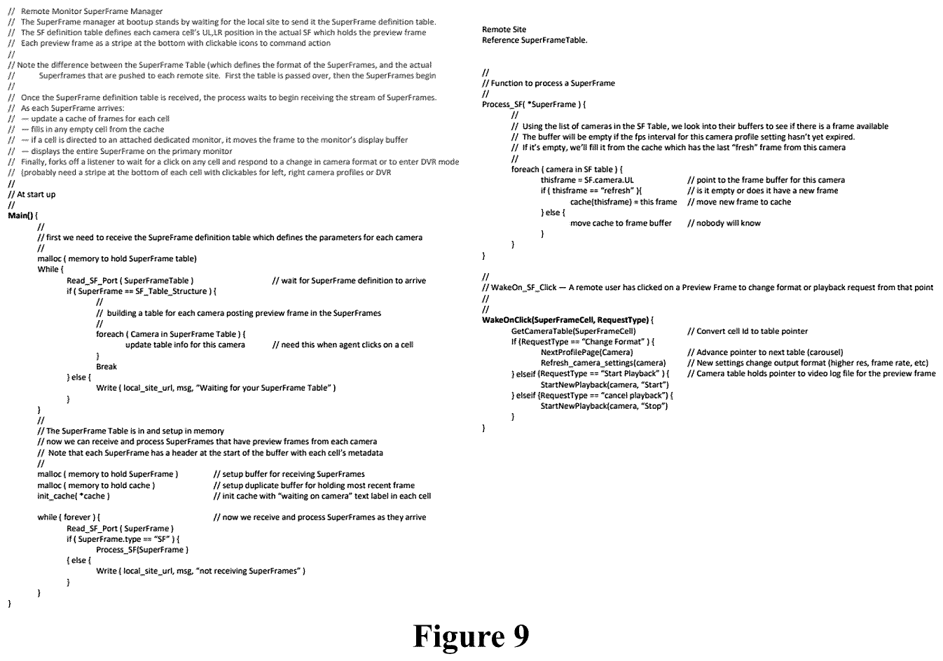

The system implements several bandwidth conserving techniques. The first is the SuperFrame manager function as shown in FIG. 8, FIG. 9. A SuperFrame manager on the local site FIG. 8 sets a timer based on the fastest frame rate of any of the cameras. When the timer expires it builds the SuperFrame with preview frames which are thumbnails that are formatted according to the pre-defined settings in the tables for each camera. A separate SuperFrame manager runs for each destination. Because some cameras may run at a lower framerate, in which case the SuperFrame manager will popular the steam with only new frames. At the receiving destination, when there is no new frame for a camera, the SuperFrame manager at the remote site FIG. 9 will use the previous frame, which is still the current frame and is stored in cache memory. This technique significantly reduces the bandwidth required to send video streams. Bandwidth savings are also possible by specifying an area of interest (AOI) that may be a relatively small portion of the scene. In the case only when the system detects a change in the AOI will a new frame be forwarded to a remote destination.

Another technique to improve the efficient routing of video streams is to combine multiple camera views into one (or more) “Poster Frames” defined for each destination. Poster Frames allow a single encoded stream to transport multiple individually optimized camera views instead of multiple camera streams.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

1. (canceled)

2. A system for routing video streams from various cameras over a digital network to various destination command centers, comprising:
a plurality of cameras monitoring a plurality of regions of interest;
a visual memory bank, configured on a computer at a local monitoring site, and wherein said visual memory bank stores an initial sighting of an object of interest in said plurality of regions of interest; and,
wherein said computer associated with said plurality of cameras that maintains settings pages for each camera;
a settings page that indicates a destination for at least one camera's video feed that is initialized with pre-defined settings unique to each remote destination; and
a bandwidth conservation module on said computer, wherein a timer corresponding with a frame rate of a video stream deriving from said plurality of cameras trigger a super frame preview formatted according to said pre-defined settings that are unique to each remote destination.

3. The system of claim 2, further comprising of said regions of interest being a line of demarcation, private property, a border, and a protected territory.

4. The system of claim 2, wherein said visual memory bank retrieves an analysis of a set of characteristics, including weight, height, size, and other physical markers of said object of interest.

5. The system of claim 2, wherein personnel at said local monitoring site can exchange and communicate through a user interface with other personnel at remote monitoring sites.

6. The system of claim 2, wherein said plurality of cameras have a camera manager to manage interactions and user interactions.

7. The system of claim 6, further comprising of said camera manager initializing and servicing each camera at said local monitoring site.

8. The system of claim 6, wherein said camera manager provides frame previews with pre-defined video presentation settings as specified by personnel at said local monitoring site.

9. A method for routing video streams from various cameras over a digital network to various destination command centers, the method comprising:
monitoring, by way of a plurality of cameras, a plurality of regions of interest;
configuring a visual memory bank on a computer at a local monitoring site;
storing, on said visual memory bank, an initial sighting of an object of interest in said plurality of regions of interest;
maintaining a settings page on said computer associated with said plurality of cameras that support customized settings pages for each camera;
presenting, by way of said visual memory bank on said computer at said local monitoring site said settings page that indicates a destination for at least one camera's video feed that is initialized with pre-defined settings unique to each remote destination; and
triggering a super frame preview, formatted according to said pre-defined settings that are unique to each remote destination by way of a bandwidth conservation module on said computer that correspond with a frame rate of a video stream deriving from said plurality of cameras.

10. The method of claim 9, further comprising of a region of interest being a line of demarcation, private property, a border, and a protected territory.

11. The method of claim 9, wherein said visual memory bank retrieves an analysis of a set of characteristics, including weight, height, size, and other physical markers of said object of interest.

12. The method of claim 9, wherein personnel at said local monitoring site can exchange and communicate through a user interface with other personnel at remote monitoring sites.

13. The method of claim 9, wherein said plurality of cameras have a camera manager to manage camera interactions and between said local monitoring site and said remote monitoring centers.

14. The method of claim 13, further comprising of said camera manager initializing and servicing each camera at said local monitoring site.

15. The method of claim 14, wherein said camera manager provides frame previews with pre-defined video settings as specified by said personnel at said local monitoring site.

16. A method for remote video monitoring using encoded video streams, the method comprising of:
capturing and receiving a plurality of video streams from a plurality of cameras in an area of interest;
monitoring, by way of a plurality of cameras, a plurality of regions of interest;
streaming said video streams, by way of a local computer configured to a plurality of network systems, remote sensing cameras, and auxiliary equipment for capturing events;
configuring a visual memory bank on a computer at a local monitoring site, storing, on said visual memory bank, an initial sighting of an object of interest in said plurality of regions of interest;
specifying a routing destination for said video streams to a plurality of remote monitoring centers;
maintaining a settings page on said computer associated with said plurality of cameras that support customized settings pages for at least one of said plurality of cameras;
applying a desired format and enhancement functionalities on to at least one or more said plurality of video streams using a pre-programmable image processing method, wherein said pre-programmable image processing method includes highlighting a region of interest and expanding a size of a frame with high level resolution;
presenting, by way of said visual memory bank on said computer at said local monitoring site said settings page that indicates a destination for said video stream from at least one camera of said plurality of cameras that is initialized with pre-defined settings unique to each remote destination; and
delivering said video streams from a local site computer to at least one of said plurality of remote monitoring centers;
analyzing said video streams for an object of interest in said area of interest and storing search parameters on a local computer at said plurality of remote monitoring centers;
indexing files to present an overview of one or more said object of interest, generating a historical archive of every sighting of said object of interest; and
alerting personnel at said plurality of remote monitoring centers when and where an object of interest has been sighted; and
triggering a super frame preview, formatted according to said pre-defined settings that are unique to each remote destination by way of a bandwidth conservation module on said computer that correspond with a frame rate of said video stream deriving from said plurality of cameras.

17. The method of claim 16, wherein said enhancement functionalities include a super frame manager that is triggered by a frame rate corresponding to said plurality of video streams and use pre-defined settings customized by each of said plurality of remote monitoring centers.

18. The method of claim 16, wherein a user is presented with a thumbnail carousel of frame previews of said plurality of video streams and store it in cache memory on said local site computer.

19. The method of claim 18, further comprising of said cache memory stored on a computer at said plurality of remote monitoring centers.

20. The method of claim 16, wherein said routing destination receives a combination of said plurality of video streams using at least one or more poster frames defined at said routing destination and transmits multiple individually optimized views from said plurality of cameras in an area of interest.

21. The method of claim 16, wherein said personnel utilize a chat and forward information, data, footage, and commentary to said plurality of remote monitoring centers, and said personnel selecting encoding options for said plurality of cameras in a region of interest, including frame rate, resolution, scaling factor and color depth.
